(19) United States
(12) Patent Application Publication
(10) Pub. No.: US 2016/0294048 A1
(43) Pub. Date: Oct. 6, 2016

(54) Antenna and Terminal

(71) Applicant: HUAWEI DEVICE CO., LTD, Shenzhen (CN)

(72) Inventors: Huiliang Xu, Shenzhen (CN); Hanyang Wang, Shenzhen (CN); Shuhui Sun, Shenzhen (CN)

(21) Appl. No.: 15/034,825

(22) PCT Filed: Mar. 13, 2014
(86) PCT No.: PCT/CN2014/073408

§ 371 Date: May 5, 2016

(51) Int. Cl. H01Q 1/38; H01Q 1/24; H01Q 1/22; H01Q 1/48

(52) U.S. Cl. CPC H01Q 1/38; H01Q 1/48; H01Q 1/243; H01Q 1/2291

(57) ABSTRACT

An antenna and a terminal, where the antenna includes a first antenna branch, printed on a first surface of a circuit board, where the first antenna branch includes a first sub-branch; a grounding branch, printed on the first surface, where the grounding branch includes a grounding sub-branch, the first sub-branch and the grounding sub-branch are staggered to form a gap, and the first antenna branch and the grounding branch are mutually coupled through the gap; a second antenna branch, printed on a second surface of the circuit board, where the second surface and the first surface are two opposite surfaces of the circuit board; and a first feed, electrically connected to the first antenna branch; where the second antenna branch is electrically connected to a metal via hole on the circuit board, and the metal via hole is electrically connected to the first feed.

### CROSS-REFERENCE TO RELATED APPLICATIONS

This application is a National Stage of International Application No. PCT/CN2014/073408, filed on Mar. 13, 2014, which is incorporated herein by reference in its entirety.

### TECHNICAL FIELD

The present disclosure relates to the field of communications technologies, and in particular, to an antenna and a terminal.

### BACKGROUND

At present, the development trend of mobile terminals is miniaturization and high performance, which causes that a design of a radio frequency (RF) component that is applied to a wireless communications system focuses on factors such as component miniaturization (compact size), low cost, and easy integration.

In the Institute of Electrical and Electronics Engineers (IEEE) 802.11 standard, it is formulated that operating frequency bands that serve wireless local area networks (WLANs) are 2.4 gigahertz (GHz) (2400 megahertz (MHz)-2500 MHz) and 5 GHz (4900 MHz-5900 MHz) frequency bands. There are many WiFi antennas that are in different product forms and can cover the two operating frequency bands. For gateways and customer premise equipment (CPE), there are antenna forms such as wall-mounted dipole antennas, or inverted-F antennas (IFAs) and Loop antennas that are printed on printed circuit boards (PCBs); for mobile WiFi hotspot products, there are antenna forms such as Loop, monopole, and IFA antennas.

Currently, WiFi antenna sizes of these products are generally large. A mobile hotspot product of which an overall size is about 100 millimeters (mm)*64 mm*14 mm is used as an example, and a spatial size of a WiFi antenna is about 25 mm*5 mm*5 mm. With the miniaturization trend of products, it is required that the WiFi antenna space be compressed and that good performance of the WiFi antenna be ensured at the same time. A WiFi ceramic antenna is a relatively good miniaturization solution, which can achieve a small-size level of occupying a clearance size about 10 mm*5 mm of a PCB board. However, this is only limited to the 2.4 GHz frequency band currently, and cannot be extended to the 5 GHz frequency band.

A WiFi antenna usually has a resonance length requirement of a quarter wavelength, and generally requires an antenna space of about 25 mm*5 mm*5 mm. Antenna space of some WiFi antennas can be optimized to 20 mm*5 mm*5 mm; however, if the size is further reduced, antenna performance is going to be affected.

It can be seen that the prior art has a technical problem that an antenna simultaneously covers multiple frequency bands and a size of the antenna is relatively large.

### SUMMARY

Embodiments of the present disclosure provide an antenna and a terminal, which are capable of ensuring that the antenna covers multiple frequency bands when a size of the antenna is reduced.

According to a first aspect, an embodiment of the present disclosure provides an antenna, where the antenna includes a first antenna branch, printed on a first surface of a circuit board, where the first antenna branch includes a first sub-branch; a grounding branch, printed on the first surface, where the grounding branch includes a grounding sub-branch, the first sub-branch and the grounding sub-branch are staggered to form a gap, and the first antenna branch and the grounding branch are mutually coupled through the gap; a second antenna branch, printed on a second surface of the circuit board, where the second surface and the first surface are two opposite surfaces of the circuit board; and a first feed, electrically connected to the first antenna branch; where the second antenna branch is electrically connected to a metal via hole on the circuit board, and the metal via hole is electrically connected to the first feed; the first antenna branch, the grounding branch, and the first feed form a first antenna, which is configured to generate a first resonance frequency; the first antenna branch, the second antenna branch, and the first feed form a second antenna, which is configured to generate a second resonance frequency.

With reference to the first aspect, in a first possible implementation manner, the number of interdigital structures of the first sub-branch is in inverse proportion to a length of the antenna.

With reference to the first aspect or the first possible implementation manner of the first aspect, in a second possible implementation manner, the antenna further includes a first capacitor, which is electrically connected to an end of the first antenna branch and a ground terminal of the circuit board, and configured to reduce an electrical length of the first antenna branch; and/or a second capacitor, which is electrically connected to an end of the second antenna branch and the ground terminal of the circuit board, and configured to reduce an electrical length of the second antenna branch.

According to a second aspect, the present disclosure provides a terminal, where the terminal includes a housing; a circuit board, disposed on a surface of the housing or inside the housing; a first antenna, disposed on a first side of the circuit board; and a processor, which is electrically connected to the first antenna, and configured to process transmit and receive signals of the first antenna; where the first antenna includes a first antenna branch, printed on a first surface of the circuit board, where the first antenna branch includes a first sub-branch; a grounding branch, printed on the first surface, where the grounding branch includes a grounding sub-branch, the first sub-branch and the grounding sub-branch are staggered to form a gap, and the first antenna branch and the grounding branch are mutually coupled through the gap; a second antenna branch, printed on a second surface of the circuit board, where the second surface and the first surface are two opposite surfaces of the circuit board; and a first feed, electrically connected to the first antenna branch; where the second antenna branch is electrically connected to a metal via hole on the circuit board, and the metal via hole is electrically connected to the first feed; the first antenna branch, the grounding branch, and the first feed form the first antenna, which is configured to generate a first resonance frequency; the first antenna branch, the second antenna branch, and the first feed form a second antenna, which is configured to generate a second resonance frequency.

With reference to the second aspect, in a first possible implementation manner, the number of interdigital structures of the first sub-branch is in inverse proportion to a length of the antenna.

With reference to the second aspect or the first possible implementation manner of the second aspect, in a second possible implementation manner, the first antenna further includes a first capacitor, which is electrically connected to an end of the first antenna branch and a ground terminal of the circuit board, and configured to reduce an electrical length of the first antenna branch; and/or a second capacitor, which is electrically connected to an end of the second antenna branch and the ground terminal of the circuit board, and configured to reduce an electrical length of the second antenna branch.

With reference to the second aspect or any possible implementation manner of the first to the second possible implementation manners of the second aspect, in a third possible implementation manner, the terminal further includes the second antenna, disposed on a second side of the circuit board, where the second side is an opposite side of the first side.

With reference to the second aspect or any possible implementation manner of the first to the third possible implementation manners of the second aspect, in a fourth possible implementation manner, the terminal further includes a third antenna, disposed on a third side of the circuit board, where the third side is adjacent to the first side, and the third antenna is configured to generate a third resonance frequency; a fourth antenna, disposed on the third side, where the fourth antenna is configured to generate a first sub-resonance frequency in the third resonance frequency; a fifth antenna, disposed on a fourth side of the circuit board, where the fourth side is opposite to the third side, and the fifth antenna is configured to generate the third resonance frequency; and a sixth antenna, disposed on the fourth side, where the sixth antenna is configured to generate the first sub-resonance frequency in the third resonance frequency.

With reference to the fourth possible implementation manner of the second aspect, in a fifth possible implementation manner, the terminal further includes a first resonance branch, disposed on the third side and between the third antenna and the fourth antenna, a size of the first resonance branch is a quarter wavelength of the first sub-resonance frequency; and/or a second resonance branch, disposed on the fourth side and between the fifth antenna and the sixth antenna, a size of the second resonance branch is a quarter wavelength of the first sub-resonance frequency.

With reference to the second aspect or any possible implementation manner of the first to the fifth possible implementation manners of the second aspect, in a sixth possible implementation manner, the terminal is a mobile phone or a wearable device.

Beneficial effects of the present disclosure are as follows.

In the embodiments of the present disclosure, an antenna is provided, including a first antenna branch, a grounding branch, a second antenna branch, and a first feed, where the first antenna branch, the grounding branch, and the first feed form a first antenna, which is configured to generate a first resonance frequency; and the first antenna branch, the second antenna branch, and the first feed form a second antenna, which is configured to generate a second resonance frequency. Therefore, the antenna can cover the first resonance frequency and the second resonance frequency. Moreover, a first sub-branch of the first antenna branch and a grounding sub-branch of the grounding branch are staggered to form a gap, which can produce a capacitance effect. Further, the first antenna branch and the grounding branch form an inductor/capacitor (LC) circuit, where the LC circuit presents a left-handed transmission line effect. This in turn reduces lengths of the first antenna branch and the grounding branch and thereby ensures that an overall size of the antenna is reduced when the antenna covers multiple frequency bands.

### BRIEF DESCRIPTION OF DRAWINGS

FIG. 1A is a schematic structural diagram of a first antenna branch and a grounding branch of a first type of antenna that are located on a first surface of a circuit board according to an embodiment of the present disclosure;

FIG. 1B is a schematic structural diagram of a second antenna branch, which is located on a second surface of a circuit board, of a first antenna according to an embodiment of the present disclosure;

FIG. 1C is a schematic structural diagram of a second antenna according to an embodiment of the present disclosure;

FIG. 2 is a schematic structural diagram of an antenna including a first capacitor and a second capacitor according to an embodiment of the present disclosure;

FIG. 3 is a schematic structural diagram of an antenna according to Embodiment 1 of the present disclosure;

FIG. 4 is a schematic diagram of a return loss of an antenna according to Embodiment 1 of the present disclosure;

FIG. 5 is a schematic structural diagram of an antenna according to Embodiment 2 of the present disclosure;

FIG. 6 is a schematic diagram of a return loss of an antenna according to Embodiment 2 of the present disclosure;

FIG. 7 is a schematic structural diagram of an antenna according to Embodiment 3 of the present disclosure;

FIG. 8 is a schematic diagram of a return loss and an isolation index of an antenna according to Embodiment 3 of the present disclosure;

FIG. 9 is a schematic structural diagram of a terminal according to an embodiment of the present disclosure; and

FIG. 10 is a schematic structural diagram of a terminal, on whose circuit board a WiFi antenna and a Long-Term Evolution (LTE) antenna are disposed, according to an embodiment of the present disclosure.

### DESCRIPTION OF EMBODIMENTS

For a technical problem that a size of an antenna is extremely large when the antenna simultaneously covers multiple frequency bands in the prior art, an embodiment of the present disclosure herein proposes an antenna, where the antenna includes a first antenna branch, a grounding branch, a second antenna branch, and a first feed, where the first antenna branch, the grounding branch, and the first feed form a first antenna, which is configured to generate a first resonance frequency; and the first antenna branch, the second antenna branch, and the first feed form a second antenna, which is configured to generate a second resonance frequency. Therefore, the antenna can cover the first resonance frequency and the second resonance frequency. Moreover, a first sub-branch of the first antenna branch and a grounding sub-branch of the grounding branch are staggered to form a gap, which can produce a capacitance effect. Further, the first antenna branch and the grounding branch form an LC circuit, where the LC circuit presents a left-handed transmission line effect. This in turn reduces lengths of the first antenna branch and the grounding branch and thereby ensures that an overall size of the antenna is reduced when the antenna covers multiple frequency bands.

The following expounds, with reference to the accompanying drawings, technical solutions in the embodiments of the present disclosure, implementation manners thereof, and corresponding accomplishable beneficial effects.

The terminal in this specification may be a wireless terminal or a wired terminal. The wireless terminal may refer to a device that provides a user with voice and/or data connectivity, a handheld device with a radio connection function, or other processing devices connected to a radio modem. The wireless terminal may communicate with one or more core networks using a radio access network (RAN). The wireless terminal may be a mobile terminal, such as a mobile phone (also referred to as a “cellular” phone), or a computer provided with a mobile terminal, for example, may be a portable, pocket-sized, handheld, computer embedded, or vehicle-mounted mobile apparatus, which exchanges voice and/or data with the radio access network. For example, it may be a device such as a personal communications service (PCS) phone, a cordless telephone set, a Session Initiation Protocol (SIP) phone, a wireless local loop (WLL) station, or a personal digital assistant (PDA). The wireless terminal may also be referred to as a system, a subscriber unit, a subscriber station, a mobile station, a mobile terminal, a remote station, an access point, a remote terminal, an access terminal, a user terminal, a user agent, a user device, or a user equipment.

The term “and/or” in this specification describes only an association relationship that describes associated objects, and indicates that three relationships may exist. For example, A and/or B may indicate the following three cases: only A exists, both A and B exist, and only B exists. In addition, the character “/” in this specification generally indicates an “or” relationship between the associated objects.

According to a first aspect, an embodiment of the present disclosure provides an antenna, where the antenna may have multiple structures. The following lists two of them for description. In an implementation process, it is not limited to the following two cases.

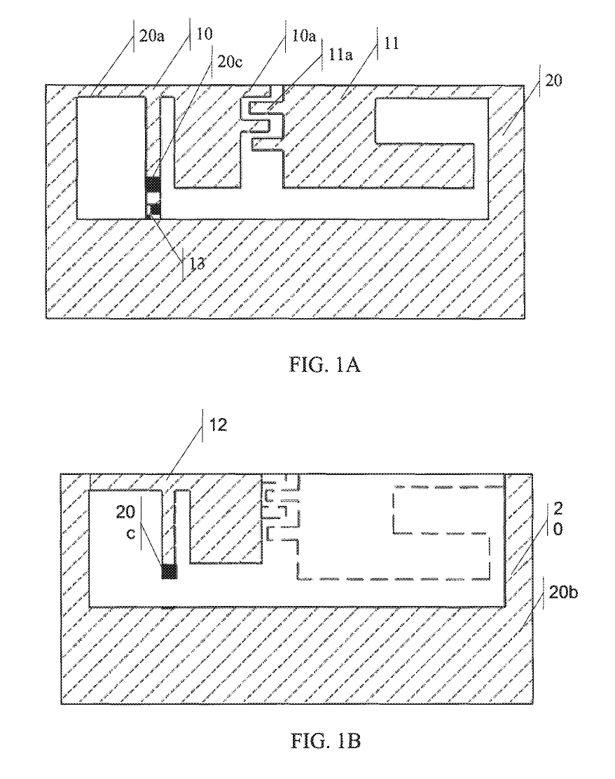

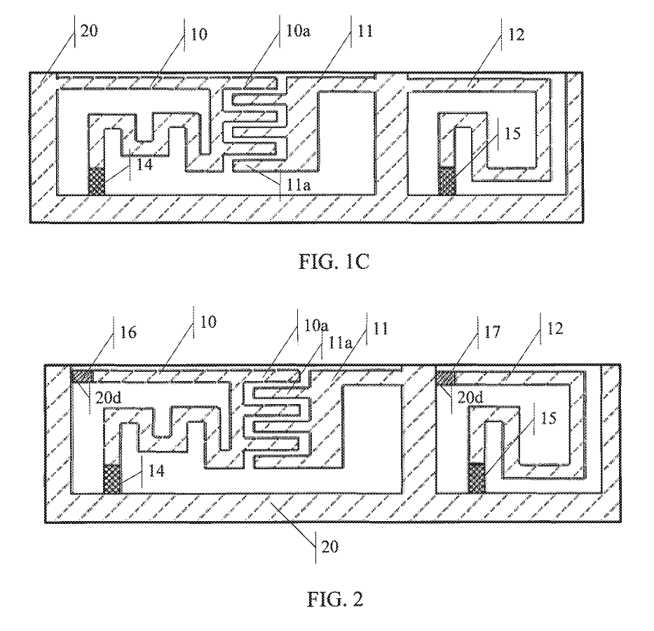

In a first case, referring to FIG. 1A and FIG. 1B, FIG. 1A is a schematic structural diagram of a first antenna branch and a grounding branch, FIG. 1B is a schematic structural diagram of a second antenna branch, and the antenna includes a first antenna branch 10, printed on a first surface 20a of a circuit board 20, where the first antenna branch 10 includes a first sub-branch 10a; and a grounding branch 11, printed on the first surface 20a, where the grounding branch 11 includes a grounding sub-branch 11a, the first sub-branch 10a and the grounding sub-branch 11a are staggered to form a gap, and the first antenna branch 10 and the grounding branch 11 are mutually coupled through the gap, such that the first antenna branch 10 and the grounding branch 11 produce a coupling capacitance effect, thereby making the first antenna branch 10 and the grounding branch 11 form an LC circuit, where the LC circuit presents a left-handed transmission line effect and can reduce a size of the antenna.

For example, in the prior art, it is assumed that an IFA antenna with 2.5 GHz resonance is printed on a PCB board, and an electrical length of the IFA antenna is about (300/2.5)/4=30 mm; considering an influence of a dielectric constant of the board, an actual size is less than 30 mm and is about 20 mm to 25 mm. If the left-handed transmission line effect is used to design the antenna, an electrical length of the antenna is about ½ that of a right-handed concept antenna, that is, about 10 mm to 12.5 mm.

The first antenna branch 10 may be an IFA antenna, a monopole antenna, a Loop antenna, or the like.

When the first antenna branch 10 is an IFA antenna or a Loop antenna, the first antenna branch 10 is electrically connected to a ground terminal of the PCB board, and the grounding branch 11 is electrically connected to a ground terminal of the PCB board.

When the first sub-branch 10a and the grounding sub-branch 11a are staggered, there is no electric connection but a gap exists between the first sub-branch 10a and the grounding sub-branch 11a, such that the first antenna branch 10 and the grounding branch 11 form gap coupling. A size range of the gap is about 0.1 mm to 0.5 mm.

A second antenna branch 12 is printed on a second surface 20b of the circuit board 20, where the first surface 20a and the second surface 20b are two opposite surfaces of the circuit board 20.

The second antenna branch 12 may be an IFA antenna, a monopole antenna, a Loop antenna, or the like. When the second antenna branch 12 is an IFA antenna or a Loop antenna, the second antenna branch 12 is electrically connected to the ground terminal of the PCB board.

A first feed 13 is electrically connected to the first antenna branch 10, where the second antenna branch 12 is electrically connected to a metal via hole 20c on the circuit board, and the metal via hole 20c is electrically connected to the first feed 13; the first antenna branch 10, the grounding branch 11, and the first feed 13 form a first antenna, which is configured to generate a first resonance frequency; the first antenna branch 10, the second antenna branch 12, and the first feed 13 form a second antenna, which is configured to generate a second resonance frequency; for example, the first resonance frequency is 2.4 GHz-2.5 GHz, and the second resonance frequency is, for example, 4.9 GHz-5.9 GHz.

Further, still referring to FIG. 1B, FIG. 1B represents a schematic diagram of an antenna layout on the second surface 20b of the circuit board, where the second antenna branch 12 is printed on the second surface 20b of the circuit board 20, and the second surface 20b and the first surface 20a are opposite surfaces. Dashed lines in FIG. 1B indicate an antenna layout on the first surface 20a of the circuit board, and no antenna is laid at a corresponding position on the second surface 20b.

In a second case, referring to FIG. 1C, the antenna includes the following structures: a first antenna branch 10, printed on a first surface 20a of a circuit board 20, where the first antenna branch 10 includes a first sub-branch 10a; a grounding branch 11, printed on the first surface 20a, where the grounding branch 11 includes a grounding sub-branch 11a, the first sub-branch 10a and the grounding sub-branch 11a are staggered to form a gap, and the first antenna branch 10 and the grounding branch 11 are mutually coupled through the gap; a second antenna branch 12, printed on the circuit board 20; where the second antenna branch 12 may be printed on the first surface 20a or a second surface 20b of the circuit board 20, where FIG. 1C is a schematic diagram in which the second antenna branch 12 is printed on the first surface 20a; a first feed 14, where the first feed 14 is electrically connected to the first antenna branch 10, and the first antenna branch 10, the grounding branch 11, and the first feed 14 form a first antenna, which is configured to generate a first resonance frequency; and a second feed 15, electrically connected to the grounding branch 11, where the second antenna branch 12 and the second feed 15 form a second antenna, which is configured to generate a second resonance frequency.

It may be seen from the above that, signals at the first resonance frequency and the second resonance frequency are sent using different feeds, and antenna wiring for the first resonance frequency and antenna wiring for the second resonance frequency can be debugged separately, thereby preventing the wiring for the first resonance frequency and the wiring for the second resonance frequency from affecting each other.

In addition, the signals at the first resonance frequency and the second resonance frequency are sent using different feeds, and a combiner may be saved in a circuit system of the antenna, thereby bringing an advantage of a component cost reduction.

Optionally, the number of interdigital structures of the first antenna sub-branch is in inverse proportion to a length of the antenna.

In an implementation process, the number of first sub-branches 10a is the same as the number of grounding sub-branches 11a, but the number of interdigital structures of the first sub-branch 10a may be any number, for example, 1, 3, 4, or the like. When the number of interdigital structures of the first sub-branch 10a is larger, intensity of a coupling capacitance effect formed between the first sub-branch 10a and the grounding sub-branch 11a is higher, and then the length of the antenna can be further reduced. That is, the number of interdigital structures of the first sub-branch 10a is in inverse proportion to the length of the antenna, where the inverse proportion refers that the length of the antenna is shortened as the number of interdigital structures of the first sub-branch 10a grows.

Optionally, referring to FIG. 2, the antenna further includes a first capacitor 16, which is electrically connected to an end of the first antenna branch 10 and a ground terminal 20d of the circuit board 20, and configured to reduce an electrical length of the first antenna branch 10; and/or a second capacitor 17, which is electrically connected to an end of the second antenna branch 12 and the ground terminal 20d of the circuit board 20, and configured to reduce an electrical length of the second antenna branch 12.

In an implementation process, in a condition with a same size, if a capacitor is connected in series to an end of an antenna branch, an effective electrical length of the antenna branch may be reduced, such that a low-frequency resonance point of the antenna branch shifts upwards, thereby shortening a length of the antenna branch. The first capacitor 16 is, for example, 2 picofarads (pF) or 1.5 pF, and the second capacitor 17 is, for example, 2 pF or 1.3 pF; the two may be the same or may be different, which is not limited in this embodiment of the present application.

As a further exemplary embodiment, the first antenna branch 10, the grounding branch 11, and the second antenna branch 12 may all be laid at edges of the circuit board 20. That is, the first antenna branch 10 may be laid on one side of the circuit board 20, the grounding branch 11 may be laid on another side of the circuit board 20, adjacent to the one side, and the second antenna branch 12 may be laid on another side of the circuit board 20, adjacent to the other side. Because there are metal ground terminals 20d on the three sides of the circuit board, which is equivalent that a structure formed by the first antenna branch 10, the grounding branch 11, and the second antenna branch 12 is embedded in the circuit board, a utilization rate of the circuit board can be improved.

The following describes an antenna in the present disclosure with reference to several embodiments, and the following embodiments mainly describe several possible implementation structures of the antenna. It should be noted that the embodiments in the present disclosure are only used to explain the present disclosure, and cannot be used to limit the present disclosure. All embodiments that comply with the idea of the present disclosure are within the protection scope of the present disclosure, and a person skilled in the art should know how to perform transformation according to the idea of the present disclosure.

### EMBODIMENT 1

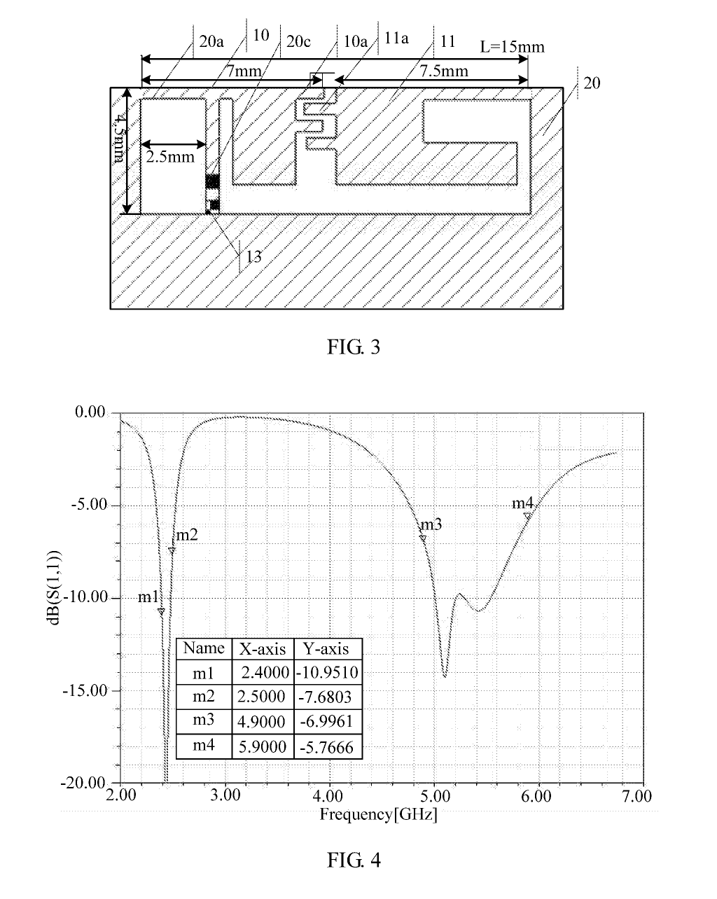

Referring to FIG. 3 and FIG. 1B, an antenna described in this embodiment includes a first antenna branch 10, printed on a front 20a of a circuit board 20, where the first antenna branch 10 may be an IFA antenna, whose length is about 7 mm and which includes two first sub-branches 10a; a grounding branch 11, which is printed on the front 20a of the circuit board 20, is shaped like an “U”, and includes two grounding sub-branches 11a, where a length of the grounding branch 11 exclusive of the grounding sub-branches 11a is 7.5 mm; a second antenna branch 12, printed on a back 20b of the circuit board 20, where the second antenna branch 12 is electrically connected to a metal via hole 20c on the circuit board 20; and a first feed 13, electrically connected to the first antenna branch 10, where the first feed 13 is electrically connected to the metal via hole 20c; and the first antenna branch 10, the grounding branch 11, and the feed 13 form a first antenna, which is configured to generate a 2.4 GHz-2.5 GHz frequency; and the first antenna branch 10, the second antenna branch 12, and the first feed 13 form a second antenna, which is configured to generate a 4.9 GHz-5.9 GHz frequency.

An antenna length L is a length from a leftmost end of the first antenna branch 10 to a rightmost end of the grounding branch 11, which is 15 mm in total; an antenna width W is 3 mm to 4.5 mm.

As shown in FIG. 4, which is a graph of a return loss curve obtained by emulating the antenna, it may be seen from the graph that a return loss at 2.4 GHz is −10.9510 decibels (dB) (that is, at m1), a return loss at 2.5 GHz is −7.6803 dB (that is, at m2), and return losses at 2.4 GHz-2.5 GHz are between −7.6803 dB and −10.9510 dB, that is, all less than −5 dB; a return loss at 4.9 GHz is −6.9961 dB (that is, at m3), a return loss at 5.9 GHz is −5.7666 dB (that is, at m4), and return losses at 4.9 GHz-5.9 GHz are between −5.7666 dB and −6.9961 dB, also all less than −5 dB. This indicates that return losses in frequency bands 2.4 GHz-2.5 GHz and 4.9 GHz-5.9 GHz meet the requirement, and efficiencies of both the frequency bands is also higher than 50%. Therefore, the antenna can ensure that the two frequency bands 2.4 GHz-2.5 GHz and 4.9 GHz-5.9 GHz are covered when its length is reduced.

As shown in Table 1, Table 1 is efficiency data of the antenna from experimental tests.

TABLE 1

| Freq. (MHz) | Effi (dB) | Effi (%) | Gain (dBi) |
|---|---|---|---|
| 2400 | −2.7 | 53.1 | 4.2 |
| 2410 | −2.6 | 54.7 | 4.4 |
| 2420 | −2.6 | 55.6 | 4.7 |
| 2430 | −2.6 | 54.9 | 4.8 |
| 2440 | −2.7 | 54.3 | 4.6 |
| 2450 | −2.7 | 54.3 | 4.3 |
| 2460 | −2.5 | 56.2 | 4.3 |
| 2470 | −2.4 | 57.7 | 4.5 |
| 2480 | −2.4 | 57.7 | 4.7 |
| 2490 | −2.7 | 54.2 | 4.4 |
| 2500 | −2.9 | 51.8 | 4.1 |
| 4900 | −4.8 | 32.9 | 0.8 |
| 5000 | −4.3 | 37.3 | 0.7 |
| 5100 | −3.3 | 46.9 | 2.2 |
| 5200 | −3.2 | 47.4 | 1.6 |
| 5300 | −3.3 | 47.1 | 2.0 |
| 5400 | −3.1 | 49.1 | 2.4 |
| 5500 | −2.7 | 54.1 | 3.1 |
| 5600 | −2.9 | 51.0 | 2.8 |
| 5700 | −2.9 | 51.9 | 2.7 |
| 5800 | −2.8 | 52.4 | 2.4 |
| 5900 | −2.8 | 52.3 | 1.7 |

It may be seen from Table 1 that in the frequency band 2.4 GHz-2.5 GHz, almost all efficiencies exceed 50%, which meets the requirement; in the frequency band 4.9 GHz-5.9 GHz, efficiencies are less than that in the frequency band 2.4 GHz-2.5 GHz, but most of them are also higher than 50%, and therefore data transmission can also be performed. It may be seen that the antenna can simultaneously cover the frequency bands 2.4 GHz-2.5 GHz and 4.9 GHz-5.9 GHz.

### EMBODIMENT 2

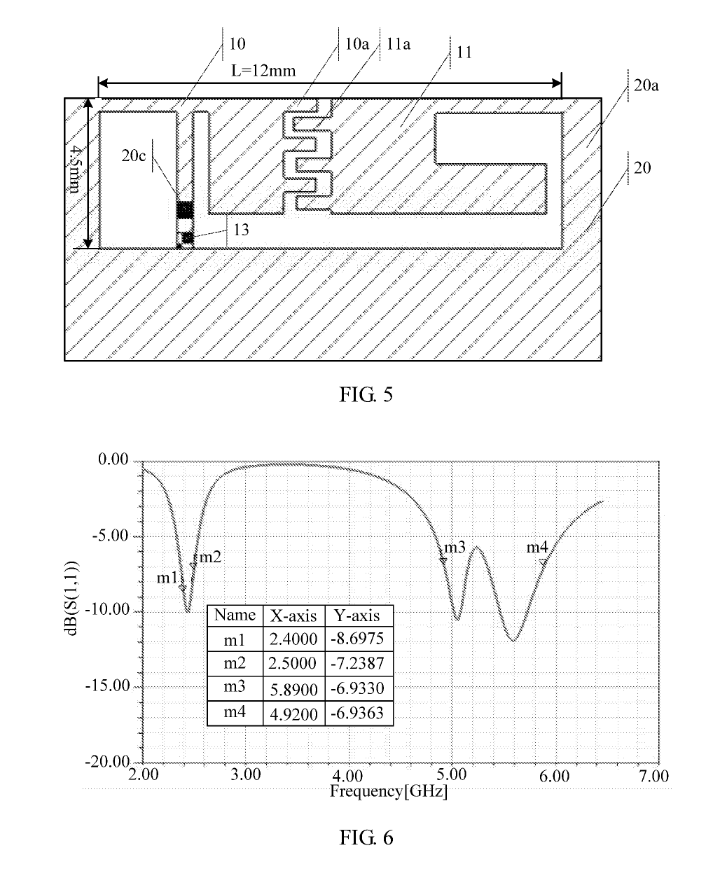

Referring to FIG. 5 and FIG. 1B, an antenna described in this embodiment of the present application includes the following structures: a first antenna branch 10, which is printed on a front 20a of a circuit board 20, is an IFA antenna, and includes three first sub-branches 10a; a grounding branch 11, which is printed on the front 20a of the circuit board 20, and includes three grounding sub-branches 11a; a second antenna branch 12, printed on a back 20b of the circuit board 20, where the second antenna branch 12 is electrically connected to a metal via hole 20c on the circuit board 20; and a first feed 13, electrically connected to the first antenna branch 10, where the metal via hole 20c is electrically connected to the first feed 13; where the first antenna branch 10, the grounding branch 11, and the first feed 13 form a first antenna, which is configured to generate a 2.4 GHz-2.5 GHz frequency; and the first antenna branch 10, the second antenna branch 12, and the first feed 13 form a second antenna, which is configured to generate a 4.9 GHz-5.9 GHz frequency. An antenna length L is a length from a leftmost end of the first antenna branch 10 to a rightmost end of the grounding branch 11, which is 12 mm in total; an antenna width w is 4.5 mm. It may be seen that, relative to Embodiment 1, the antenna length L is reduced when the number of first sub-branches 10a is increased.

As shown in FIG. 6, which is a graph of a return loss curve obtained by emulating the antenna, it may be seen from the graph that a return loss at 2.4 GHz is −8.6975 dB (that is, at m1), a return loss at 2.5 GHz is −7.2387 dB (that is, at m2), and return losses at 2.4 GHz-2.5 GHz are between −7.2387 dB and −8.6975 dB, that is, all less than −5 dB; a return loss at 4.92 GHz is −6.9330 dB (that is, at m3), a return loss at 5.89 GHz is −6.9363 dB (that is, at m4), and return losses at 4.92 GHz-5.89 GHz are between −6.9330 dB and −6.9363 dB, and therefore return losses in a frequency band 4.9 GHz-5.9 GHz are all less than −5 dB. This indicates that return losses in frequency bands 2.4 GHz-2.5 GHz and 4.9 GHz-5.9 GHz meet the requirement.

It may be seen that, the antenna can ensure that the two frequency bands 2.4 GHz-2.5 GHz and 4.9 GHz-5.9 GHz are covered when its length is reduced.

### EMBODIMENT 3

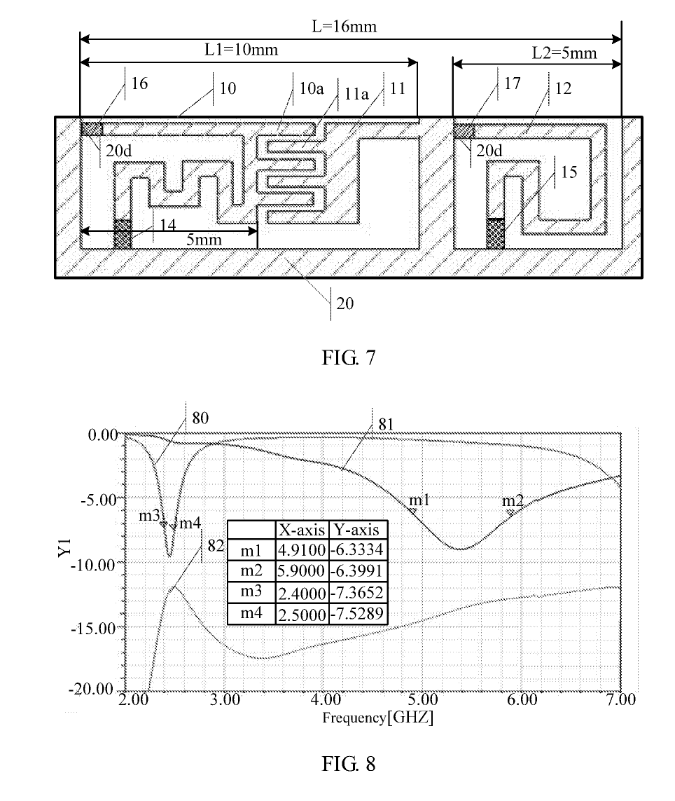

Referring to FIG. 7, an antenna described in this embodiment of the present application includes a first antenna branch 10, printed on a front 20a of a circuit board 20, where the first antenna branch 10 may include three first sub-branches 10a; a grounding branch 11, which is printed on the front 20a of the circuit board 20, and includes three grounding sub-branches 11a, where a length L1 from a leftmost end of the first antenna branch 10 to a rightmost end of the grounding branch 11 is 10 mm; a second antenna branch 12, which is printed on the front 20a of the circuit board 20, and is a LOOP antenna, whose length L2 is about 5 mm, where the second antenna branch 12 is electrically connected to a ground terminal of the PCB board; a first feed 14, connected to the first antenna branch 10, where the first antenna branch 10, the grounding branch 11, and the first feed 14 form a first antenna, which is configured to generate a frequency between 2.4 GHz-2.5 GHz; a second feed 15, connected to the second antenna branch 12, where the second antenna branch 12 and the second feed 15 form a second antenna, which is configured to generate a frequency between 4.9 GHz-5.9 GHz; a first capacitor 16, which is electrically connected to an end of the first antenna branch 10 and a ground terminal 20d of the circuit board 20, and configured to reduce an electrical length of the first antenna branch 10; and a second capacitor 17, which is electrically connected to an end of the second antenna branch 12 and the ground terminal 20d of the circuit board 20, and configured to reduce an electrical length of the second antenna branch 12.

A length L of the antenna is a length from the leftmost end of the first antenna branch 10 to a rightmost end of the second antenna branch 12, which is 16 mm.

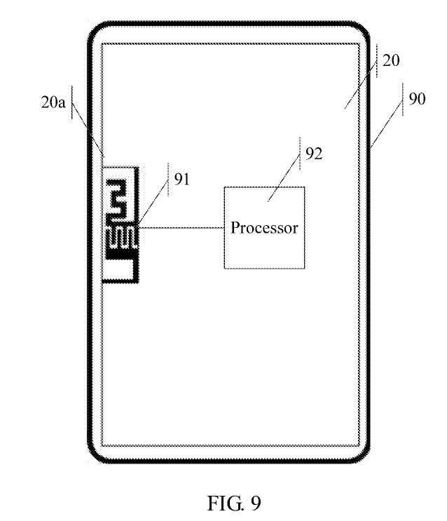

Referring to FIG. 8, which is a schematic diagram of emulation of return losses and isolation indexes of the antenna, it may be seen from the diagram that two return loss curves are included; in a curve 80 for the frequency band 2.4 GHz-2.5 GHz, a return loss at 2.4 GHz is −7.3652 dB (that is, at m3), a return loss at 2.5 GHz is −7.5289 dB (that is, at m4), and return losses at 2.4 GHz-2.5 GHz are between −7.3652 dB and −7.5289 dB, that is, all less than −5 dB; in a curve 81 for the frequency band 4.9 GHz-5.9 GHz, a return loss at 4.91 GHz is −6.3334 dB (that is, at m1), a return loss at 5.9 GHz is −6.3991 dB (that is, at m2), and return losses at 4.91 GHz-5.9 GHz are between −6.3334 dB and −6.3991 dB, and therefore all return losses in the frequency band 4.9 GHz-5.9 GHz are also less than −5 dB. This indicates that return losses in frequency bands 2.4 GHz-2.5 GHz and 4.9 GHz-5.9 GHz meet the requirement. In an isolation curve 82, the isolation at every frequency is less than −10 dB, and therefore the isolation is good. Therefore, the antenna can ensure that the two frequency bands 2.4 GHz-2.5 GHz and 4.9 GHz-5.9 GHz are covered when its length is reduced, and can debug the two frequency bands 2.4 GHz-2.5 GHz and 4.9 GHz-5.9 GHz separately, such that debugging is more convenient.

According to a second aspect, this embodiment of the present disclosure provides a terminal, where the terminal is, for example, a mobile phone or a wearable device. Referring to FIG. 9, the terminal includes a housing 90; a circuit board 20, disposed on a surface of the housing 90 or inside the housing 90; a first antenna 91, disposed on a first side of the circuit board 20; and a processor 92, which is electrically connected to the first antenna 91, and configured to process transmit and receive signals of the first antenna 91.

Referring to FIGS. 1A, 1B, and 1C, the first antenna 91 includes a first antenna branch 10, printed on a first surface 20a of the circuit board 20, where the first antenna branch 10 includes a first sub-branch 10a; a grounding branch 11, printed on the first surface 20a, where the grounding branch 11 includes a grounding sub-branch 11a, the first sub-branch 10a and the grounding sub-branch 11a are staggered to form a gap, and the first antenna branch 10 and the grounding branch 11 are mutually coupled through the gap; a second antenna branch 12, printed on a second surface 20b of the circuit board 20, where the second surface 20b and the first surface 20a are two opposite surfaces of the circuit board 20; and a first feed 13, electrically connected to the first antenna branch 10; where the second antenna branch 12 is electrically connected to a metal via hole 20c on the circuit board 20, and the metal via hole 20c is electrically connected to the first feed 13; the first antenna branch 10, the grounding branch 11, and the first feed 13 form the first antenna, which is configured to generate a first resonance frequency; and the first antenna branch 10, the second antenna branch 12, and the first feed 13 form a second antenna, which is configured to generate a second resonance frequency.

Optionally, the number of interdigital structures of the first sub-branch 10a is in inverse proportion to a length of the antenna.

Optionally, referring to FIG. 2, the first antenna further includes a first capacitor 16, which is electrically connected to an end of the first antenna branch 10 and a ground terminal 20d of the circuit board 20, and configured to reduce an electrical length of the first antenna branch 10; and/or a second capacitor 17, which is electrically connected to an end of the second antenna branch 12 and the ground terminal 20d of the circuit board 20, and configured to reduce an electrical length of the second antenna branch 12.

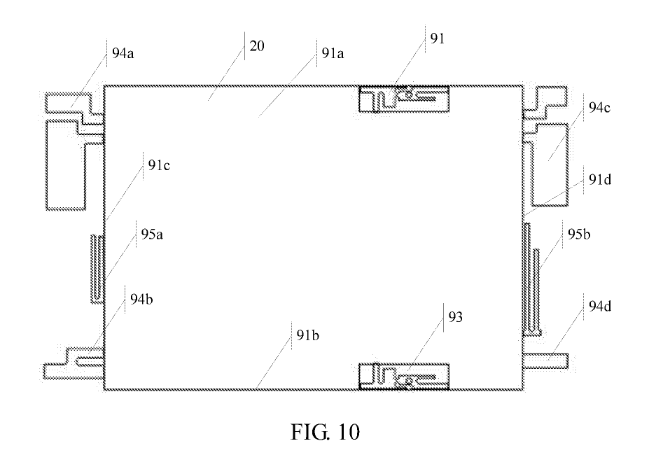

Optionally, referring to FIG. 10, the antenna further includes a second antenna 93, disposed on a second side 91b of the circuit board, where the second side 91b is an opposite side of the first side 91a.

In such a case, it can be ensured that pattern coverage of the first antenna 91 and the second antenna 93 can achieve omnidirectional coverage.

Optionally, still referring to FIG. 10, the antenna further includes a third antenna 94a, disposed on a third side 91c of the circuit board 20, where the third side 91c is adjacent to the first side 91a, the third antenna 94a is configured to generate a third resonance frequency, and the third resonance frequency is, for example, at least one frequency band among 815 MHz-960 MHz, 1420 MHz-1520 MHz, 1710 MHz-2170 MHz, and 2490 MHz-2700 MHz; a fourth antenna 94b, disposed on the third side 91c, where the fourth antenna 94b is configured to generate a first sub-resonance frequency in the third resonance frequency, and the first sub-resonance frequency is, for example, 2490 MHz-2700 MHz; a fifth antenna 94c, disposed on a fourth side 91d of the circuit board 20, where the fourth side 91d is opposite to the third side 91c, and the fifth antenna 94c is configured to generate the third resonance frequency; generally, the fifth antenna 94c is a transmit and receive diversity antenna of the third antenna 94a, and therefore the fifth antenna 94c operates only in a receive frequency band of the third resonance frequency, for example, at least one frequency band among 860 MHz-960 MHz, 1470 MHz-1520 MHz, 1700 MHz-2170 MHz, and 2490 MHz-2700 MHz; and a sixth antenna 94d, disposed on the fourth side 91d, where the sixth antenna 94d is configured to generate the first sub-resonance frequency in the third resonance frequency, and a second sub-resonance frequency is, for example, 2490 MHz-2700 MHz.

The foregoing solution provides a new layout solution of a Long Term Evolution (LTE) antenna and a WiFi antenna in a 4×4 multiple-input multiple-output (MIMO) system, where the first antenna 91 and the second antenna 93 are laid on opposite sides of the circuit board to implement omnidirectional coverage of the WiFi antenna, and the third antenna 94a, the fourth antenna 94b, the fifth antenna 94c, and the sixth antenna 94d implement omnidirectional coverage of the LTE antenna.

Optionally, still referring to FIG. 10, the antenna includes a first resonance branch 95a, disposed on the third side 91c, where the first resonance branch 95a is located between the third antenna 94a and the fourth antenna 94b, and a size of the first resonance branch 95a is a quarter wavelength of the first sub-resonance frequency; and/or a second resonance branch 95b, disposed on the fourth side 91d, where the second resonance branch 95b is located between the fifth antenna 94c and the sixth antenna 94d, and a size of the second resonance branch 95b is a quarter wavelength of the first sub-resonance frequency.

That the first sub-resonance frequency is 2490 MHz-2700 MHz is used as an example, and then, if the antenna has the first resonance branch 95a, a length of the first resonance branch 95a is a quarter wavelength of 2490 MHz-2700 MHz; if the antenna has the second resonance branch 95b, a length of the second resonance branch 95b is about a quarter wavelength of 2490 MHz-2700 MHz.

Current distribution of the third antenna 94a and the fourth antenna 94b on the PCB board can be changed using the first resonance branch 95a disposed on the circuit board 20, thereby improving isolation between the third antenna 94a and the fourth antenna 94b, and preventing mutual interference between the third antenna 94a and the fourth antenna 94b; current distribution of the fifth antenna 94c and the sixth antenna 94d can be changed using the second resonance branch 95b disposed on the circuit board 91, thereby improving isolation between the fifth antenna 94c and the sixth antenna 94d, and preventing mutual interference between the fifth antenna 94c and the sixth antenna 94d.

One or more embodiments of the present disclosure have at least the following beneficial effects.

In the embodiments of the present disclosure, an antenna and a terminal are provided, where the antenna includes a first antenna branch, a grounding branch, a second antenna branch, and a first feed, or further includes a second feed, where the first antenna branch, the grounding branch, and the first feed form a first antenna, which is configured to generate a first resonance frequency; the first antenna branch, the second antenna branch, and the first feed form a second antenna, which is configured to generate a second resonance frequency; or the first antenna branch, the grounding branch, and the first feed form a first antenna, which is configured to generate a first resonance frequency; the second antenna branch and the second feed form a second antenna, which is configured to generate a second resonance frequency. Therefore, the antenna can cover multiple frequency bands including the first resonance frequency and the second resonance frequency. Moreover, a first sub-branch of the first antenna branch and a grounding sub-branch of the grounding branch can be staggered to produce a capacitance effect. Further, the first antenna branch and the grounding branch form an LC circuit, where the LC circuit presents a left-handed transmission line effect. This in turn reduces a sum of lengths of the first antenna branch and the grounding branch and thereby ensures that an overall size of the antenna is reduced when the antenna covers multiple frequency bands.

Although some preferred embodiments of the present disclosure have been described, persons skilled in the art can make changes and modifications to these embodiments once they learn the basic inventive concept. Therefore, the following claims are intended to be construed as to cover the exemplary embodiments and all changes and modifications falling within the scope of the present disclosure.

A person skilled in the art can make various modifications and variations to the present disclosure without departing from the spirit and scope of the present disclosure. The present disclosure is intended to cover these modifications and variations provided that they fall within the scope of protection defined by the following claims and their equivalents.

1. An antenna, comprising:
a first antenna branch, printed on a first surface of a circuit board, wherein the first antenna branch comprises a first sub-branch;
a grounding branch, printed on the first surface, wherein the grounding branch comprises a grounding sub-branch, wherein the first sub-branch and the grounding sub-branch are staggered to form a gap, and wherein the first antenna branch and the grounding branch are mutually coupled through the gap;
a second antenna branch, printed on a second surface of the circuit board, wherein the second surface and the first surface are two opposite surfaces of the circuit board; and
a first feed, electrically connected to the first antenna branch,
wherein the second antenna branch is electrically connected to a metal via hole on the circuit board, wherein the metal via hole is electrically connected to the first feed, wherein the first antenna branch, the grounding branch, and the first feed form a first antenna, which is configured to generate a first resonance frequency, and wherein the first antenna branch, the second antenna branch, and the first feed form a second antenna, which is configured to generate a second resonance frequency.

2. The antenna according to claim 1, wherein the number of interdigital structures of the first sub-branch is in inverse proportion to a length of the antenna.

2. The antenna according to claim 2, further comprising:
a first capacitor, which is electrically connected to an end of the first antenna branch and a ground terminal of the circuit board, and configured to reduce an electrical length of the first antenna branch; and
a second capacitor, which is electrically connected to an end of the second antenna branch and the ground terminal of the circuit board, and configured to reduce an electrical length of the second antenna branch.

4. A terminal, comprising:
a housing;
a circuit board, disposed on a surface of the housing or inside the housing;
a first antenna, disposed on a first side of the circuit board; and
a processor, which is electrically connected to the first antenna, and configured to process transmit and receive signals of the first antenna,
wherein the first antenna comprises:
a first antenna branch, printed on a first surface of the circuit board, wherein the first antenna branch comprises a first sub-branch;
a grounding branch, printed on the first surface, wherein the grounding branch comprises a grounding sub-branch, wherein the first sub-branch and the grounding sub-branch are staggered to form a gap, and wherein the first antenna branch and the grounding branch are mutually coupled through the gap;
a second antenna branch, printed on a second surface of the circuit board, wherein the second surface and the first surface are two opposite surfaces of the circuit board; and
a first feed, electrically connected to the first antenna branch,
wherein the second antenna branch is electrically connected to a metal via hole on the circuit board,
wherein the metal via hole is electrically connected to the first feed,
wherein the first antenna branch, the grounding branch, and the first feed form the first antenna, which is configured to generate a first resonance frequency, and
wherein the first antenna branch, the second antenna branch, and the first feed form a second antenna, which is configured to generate a second resonance frequency.

5. The terminal according to claim 4, wherein the number of interdigital structures of the first sub-branch is in inverse proportion to a length of the first antenna.

6. The terminal according to claim 5, wherein the first antenna further comprises:
a first capacitor, which is electrically connected to an end of the first antenna branch and a ground terminal of the circuit board, and configured to reduce an electrical length of the first antenna branch; and
a second capacitor, which is electrically connected to an end of the second antenna branch and the ground terminal of the circuit board, and configured to reduce an electrical length of the second antenna branch.

7. The terminal according to claim 4, further comprising: the second antenna, disposed on a second side of the circuit board, wherein the second side is an opposite side of the first side.

8. The terminal according to claim 7, further comprising:
a third antenna, disposed on a third side of the circuit board, wherein the third side is adjacent to the first side, and wherein the third antenna is configured to generate a third resonance frequency;
a fourth antenna, disposed on the third side, wherein the fourth antenna is configured to generate a first sub-resonance frequency in the third resonance frequency;
a fifth antenna, disposed on a fourth side of the circuit board, wherein the fourth side is opposite to the third side, and wherein the fifth antenna is configured to generate the third resonance frequency; and
a sixth antenna, disposed on the fourth side, wherein the sixth antenna is configured to generate the first sub-resonance frequency in the third resonance frequency.

9. The terminal according to claim 8, comprising:
a first resonance branch, disposed on the third side and between the third antenna and the fourth antenna, wherein a size of the first resonance branch is a quarter wavelength of the first sub-resonance frequency; and
a second resonance branch, disposed on the fourth side and between the fifth antenna and the sixth antenna, wherein a size of the second resonance branch is a quarter wavelength of the first sub-resonance frequency.

10. The terminal according to claim 4, wherein the terminal is a mobile phone or a wearable device.
